(19) United States
(12) Patent Application Publication
(10) Pub. No.: US 2006/0039397 A1
(43) Pub. Date: Feb. 23, 2006

(54) Sagacious routing engine, method of routing and a communications network employing the same

(75) Inventors: Adiseshu Hari, Monmouth, NJ (US); Volker Hilt, Middletown, NJ (US); Markus A. Hofmann, Fair Haven, NJ (US)

Correspondence Address: HITT GAINES P.C., P.O. BOX 832570, RICHARDSON, TX, 75083, US

(73) Assignee: Lucent Technologies Inc., Murray Hill, NJ (US)

(21) Appl. No.: 10/920,683

(22) Filed: Aug. 18, 2004

(51) Int. Cl. H04L 12/28

(52) U.S. Cl. 370/431; 370/352

(57) ABSTRACT

The present invention provides a sagacious routing engine for use with a session initiation protocol (SIP) call. In one embodiment, the sagacious routing engine includes a request manager configured to receive a routing request for an integrated routing target set for the SIP call within a network. Additionally, the sagacious routing engine also includes a route manager, coupled to the request manager, configured to employ a dynamic routing table for the routing request to provide the integrated routing target set to the request manager for routing the SIP call within the network.

### TECHNICAL FIELD OF THE INVENTION

The present invention is directed, in general, to communications systems and, more specifically, to a sagacious routing engine, a method of routing a session initiation protocol (SIP) call and a communications network employing the engine or the method.

### BACKGROUND OF THE INVENTION

Organizations worldwide seek to reduce the rising costs associated with various forms of communications. Efforts to consolidate separate voice, fax and data resources offers an opportunity for significant savings. These organizations are pursuing solutions that will enable them to take advantage of excess capacity on broadband data networks to accommodate voice, fax and data transmissions as an alternative to costlier mediums.

Voice over Internet protocol (VOIP) is an Internet protocol (IP) telephony that refers to voice communications services that are transported via an IP-based data network, such as the Internet, rather than the public switched telephone network (PSTN). IP networks use packet or cell switching technologies in contrast to circuit switching technologies used by the PSTN. Basic steps involved in a VOIP telephone call include conversion of the originating analog signal into a signal having a digital format. Then compression and translation of this digital signal into IP packets allows transmission over the IP network. The process is reversed at the receiving end of the transmission thereby again providing an analog signal for reception.

Session initiation protocol (SIP) is a signaling protocol used for creating, modifying and terminating sessions, such as IP voice calls or multimedia conferences, that have one or more participants in an IP network. SIP is a request-response protocol used in VOIP that closely resembles HTTP and SMTP, which are the two Internet protocols that power the World Wide Web and e-mail, respectively. The SIP user agent and the SIP proxy server are basic components that support the use of SIP. The SIP user agent is effectively the end system component for the call, and the SIP proxy server handles the signaling associated with multiple calls. This architecture allows peer-to-peer calls to be accomplished using client-server protocol.

A media gateway links the packet-switched IP network with the circuit-switched PSTN. The media gateway terminates voice calls on the inter-switched trunks from the PSTN, compresses and forms packets of the voice data and delivers the compressed voice packets to the IP network. For call origination in the IP network, the media gateway performs the reverse of this order. The media gateway controller accomplishes the registration and management of resources (provisioning) at the media gateway.

Current call-routing techniques provide solutions that include several potential problems or inefficiencies. For example, number portability enables a switch to support numbers that are outside its original numbering plan. However, call triangulation may typically occur leading to inefficient routing of the call. Additionally, a roaming cell phone may also be connected to a switch that is outside its home network. In such cases, if a call to the roaming cell phone is routed to its home network, inefficient routing typically results.

A coder/decoder (codec) performs analog or digital transformations on a data stream or analog signal as appropriate. A media gateway typically supports only a limited set of codecs. If selected for routing, an inappropriate media gateway can cause a call to fail or to provide an unacceptable quality of service when the desired codec is not available. Also, separate network distances employed in an IP/PSTN interworking used to route a call can generate inefficiencies and other problem areas. These factors are influenced by end device location, packet loss rates, carrier and user preferences and policies, as well as other business related arrangements and issues.

Accordingly, what is needed in the art is a way to enhance the efficiency and effectiveness of media gateway selection for routing SIP calls in applicable networks.

### SUMMARY OF THE INVENTION

To address the above-discussed deficiencies of the prior art, the present invention provides a sagacious routing engine for use with a session initiation protocol (SIP) call. In one embodiment, the sagacious routing engine includes a request manager configured to receive a routing request for an integrated routing target set for the SIP call within a network. Additionally, the sagacious routing engine also includes a route manager, coupled to the request manager, configured to employ a dynamic routing table for the routing request and to provide the integrated routing target set to the request manager for routing the SIP call within the network.

In another aspect, the present invention provides a method of routing a session initiation protocol (SIP) call. In one embodiment, the method includes receiving a routing request for an integrated routing target set for the SIP call within a network and employing a dynamic routing table for the routing request to provide the integrated routing target set for routing the SIP call within the network.

The present invention also provides, in yet another aspect, a communications network that includes an Internet protocol (IP) domain and a public switched telephone network (PSTN) domain. The communications network also includes a sagacious routing engine, coupled to the IP domain and the PSTN domain, for use with a session initiation protocol (SIP) call. The sagacious routing engine has a request manager that receives a routing request for an integrated routing target set for the SIP call. The sagacious routing engine also has a route manager, coupled to the request manager, that employs a dynamic routing table for the routing request to provide the integrated routing target set to the request manager for routing the SIP call. The sagacious routing engine further includes a media gateway, coupled to the IP domain and the PSTN domain, that constitutes at least a portion of the integrated routing target set for routing the SIP call.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a network diagram of an embodiment of a communications network constructed in accordance with the principles of the present invention;

FIG. 2 illustrates a network diagram of an embodiment of a communications network wherein a sagacious routing engine is constructed in accordance with the principles of the present invention and employed to prevent call triangulation;

FIG. 3 illustrates a network diagram of an embodiment of a communications network wherein a sagacious routing engine, constructed in accordance with the principles of the present invention, is employed to accommodate a roaming mobile phone;

FIG. 4 illustrates a network diagram of an embodiment of a communications network wherein a sagacious routing engine is employed to provide a feature set support employing the principles of the present invention;

FIG. 5 illustrates a network diagram of an embodiment of a communications network wherein a sagacious routing engine is again constructed in accordance with the principles of the present invention and employed to minimize a network distance;

FIG. 6 illustrates a block diagram of an embodiment of an implementation architecture employing a sagacious routing engine constructed in accordance with the principles of the present invention; and

FIG. 7 illustrates a system diagram of an embodiment of a sagacious routing engine constructed in accordance with the principles of the present invention.

### DETAILED DESCRIPTION

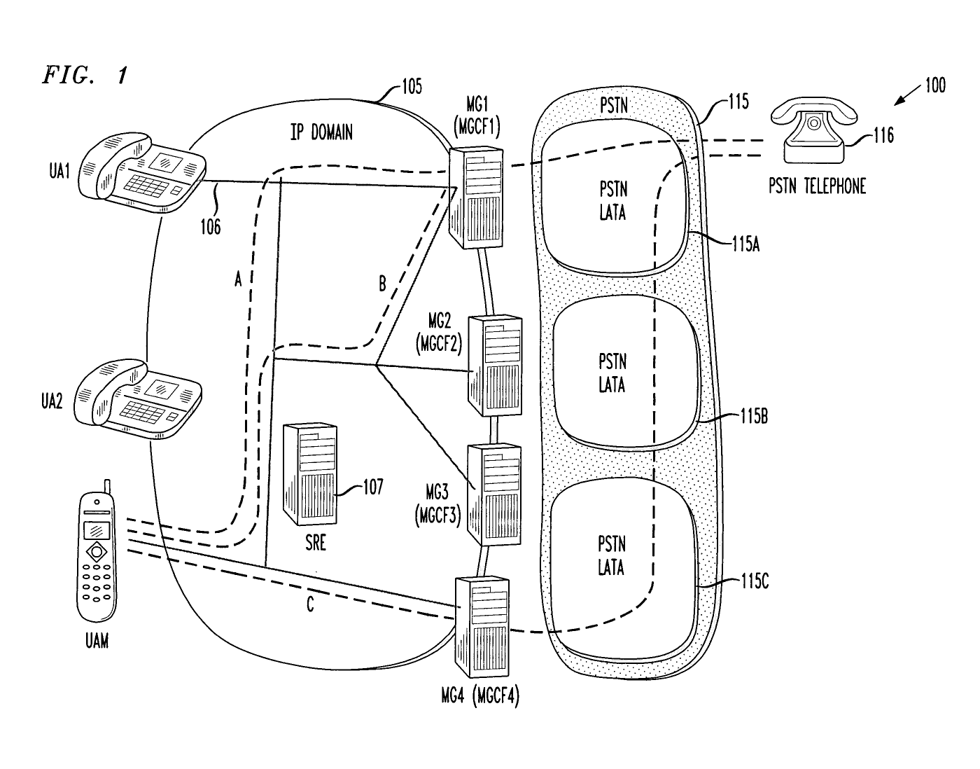

Referring initially to FIG. 1, illustrated is a network diagram of an embodiment of a communications network, generally designated 100, constructed in accordance with the principles of the present invention. The communications network 100 includes an Internet protocol (IP) domain 105 employing a topology of routing options 106 and a public switched telephone network (PSTN) domain 115 employing first, second and third PSTN local access and transport areas (LATAs) 115A, 115B, 115C. The IP domain 105 includes first and second stationary user agents UA1, UA2 and a mobile user agent UAM. The PSTM includes a PSTN telephone 116. Any of the user agents may be employed to support a call with the PSTN telephone 116.

The communications network 100 employs an IP multimedia subsystem (IMS) service architecture, which supports the deployment of Voice over IP (VOIP). Additionally, the communications network 100 is a hybrid network that employs both wireless and wireline networks. In alternative embodiments of the present invention, the communications network 100 may be solely wireless or solely wireline as a particular embodiment may dictate.

The communications network 100 also includes first, second, third and fourth media gateways MG1, MG2, MG3, MG4 (collectively designated as the media gateways MG1-MG4) having corresponding media gateway control functions MGCF1, MGCF2, MGCF3, MGCF4. The media gateways MG1-MG4 are coupled to the IP domain 105 and the PSTN domain 115, as shown. The communications network 100 further includes a sagacious routing engine (SRE) 107 that is coupled to the IP domain 105 and the PSTN domain 115 and is employed with a session initiation protocol (SIP) call.

The SRE 107 includes a request manager that receives a routing request for an integrated routing target set for the SIP call. The SRE 107 also includes a route manager, coupled to the request manager, that employs a dynamic routing table for the routing request to provide the integrated routing target set to the request manager for routing the SIP call within the communications network 100. The integrated routing target set is an ordered set of alternate SIP destinations. The SRE 107 is coupled to the media gateways MG1-MG4 and selects at least one to constitute at least a portion of the integrated routing target set for routing the SIP call.

The integrated routing target set employs an integrated routing path for routing the SIP call. This integrated routing path is based on network characteristics and incorporates a quality-of-service (QoS) metric for the path. While this concept may exist as an important characteristic in IP networks, it typically has not existed before in PSTN networks. By employing the path QoS metric with other metrics used by the SRE 107 in its integrated routing determinations, the SRE 107 provides a dynamic, measurement-based routing that substantially optimizes the end-to-end path across both the IP and PSTN domains 105, 115.

The structure of the dynamic routing table is based on at least one call-independent characteristic that is associated with a condition of the communications network 100. These call-independent characteristics may typically be dynamic network quantities that are longer term or more slowly varying. The request manager may enhance the integrated routing target set returned by the dynamic routing table based on at least one call-dependent characteristic of the communications network 100. These call-dependent characteristics may result from last-minute load and traffic probing that could, for example, substitute media gateways or reallocate an ordering of media gateways employed in the integrated routing target set provided by the dynamic routing table.

In current networks, routing of voice calls takes place in multiple routing components as a call traverses a network, with each component modifying the route. For example, the current implementation of local number portability (LNP) in the American PSTN network causes a call to be routed towards the original network of the callee. It is the responsibility of the penultimate network to determine, in case its not done earlier, if the callee number has been ported, by employing the LNP database. If the number has been ported, the penultimate network has to reroute the call to a new destination network thereby typically resulting in a non-optimal routing of the call.

As a result, the route taken by the call may not be as optimal as if all the routing decisions were integrated. For a call to be routed effectively, an integrated routing path needs to be defined before the call is routed. Alternatively, the later in the call path that an integrated determination is made, the less its effect. The selection of a media gateway, which is an important entity in routing a call, offers an excellent point in a network for establishing an integrated routing path. Additionally, efficient IP/PSTN interworking will also be important for integrated path routing.

In the illustrated embodiment, the deployment of VOIP afforded by the communications network 100 provides effective and efficient IP/PSTN interworking according to specifications that comply with both the 3^{rd} Generation Partnership Project (3GPP) and the 3^{rd} Generation Partnership Project 2 (3GPP2). However, the principles of the present invention may be applied to other current or future-defined communications networks that provide an interworking of packet-switched and circuit-switched networks, as well.

The SRE 107 embodies the key motivation of integrated call routing by employing an algorithm for media gateway selection, which is based on a number of additional input characteristics and policies. This practice replaces just using a static table based on the destination number to map an incoming request to a media gateway. For example, integrated route lookups as well as preferences and policies related to the caller, the callee or the network may be incorporated to resolve a destination number to a new number. This may be based on the caller's abbreviated dial plan, the callee's call forwarding number, or the network operator's legal call intercept requirements.

The SRE 107 provides integrated path routing by employing a flexible implementation architecture to accommodate different distance metrics in both IP networks and PSTNS, local number portability, roaming mobile phones, media gateway load and media gateway codec support. A key feature of the implementation includes a clear separation between dynamic routing table algorithms that modify the dynamic routing table for all routing requests, and request manager algorithms that are invoked on a lookup basis for each request. These routing lookups are employed to resolve incoming requests to appropriate media gateways. Additionally, support for both local and remote routing is included and in-line architecture for modules associated with load probing and HLR/LNP lookup are employed. These may modify an integrated routing target set that is retrieved from the dynamic routing table.

Integrated routing algorithms for gateway selection may also consider multiple factors. These factors include location of the end devices used, dynamic network characteristics such as load and “network distance”, packet loss rate, number of hops in IP networks, carrier/user preferences and policies and business arrangements. The support of more sophisticated call routing in an IMS based VOIP architecture may be based on multiple metrics that include, for example, routing path length, gateway overload, codec and feature selections and carrier/user service profiles and policies. Metrics pertaining to lookups may include integrated local number portability (LNP), wireless LNP (WLNP), home location register (HLR), home subscriber server (HSS) and telephony routing over IP (TRIP), for example.

Furthermore, an algorithmic approach may be used to make the media gateway selection process adaptive to network conditions with overriding consideration to service level agreements (SLAs). For example, a first media gateway that provides an optimal PSTN path to a destination may be replaced by a second media gateway, if the IP path delay afforded by the first media gateway is too great due to network congestion. Conversely, a media gateway with a low-delay IP path to the caller may be replaced by another media gateway with a greater delay that is more optimal for the PSTN path, if doing so still meets the customer SLA.

The SRE 107 is responsible for selecting and routing calls to the most appropriate media gateway control function, which represents a controlling entity for a media gateway into the PSTN 115. While a current focus may be specific to the 3GPP IMS architecture, the functionality described for the illustrated embodiment of the SRE 107 is typical for media gateway selection and intelligent path routing employed in other embodiments of VOIP networks.

In the IP domain 105 of FIG. 1, the mobile user agent UAM initiates a call to the PSTN telephone 116 by creating an SIP INVITE message. Although not specifically shown, this message is routed through the IMS structure of the communications network 100 until it reaches a serving call session control function (S-CSCF), which is the SIP proxy responsible for processing this request from a user. The S-CSCF retrieves the user profile from a home subscriber server (also not specifically shown) and examines the called party address to determine call routing. Since the called party is the PSTN telephone 116, the S-CSCF determines that a breakout to the PSTN 115 is required.

The SRE 107 is the IMS entity responsible for routing all calls to the PSTN 115, and the S-CSCF relinquishes the request to the SRE 107. At this point, the SRE 107 determines that the breakout needs to occur in the local IMS network shown and applies its routing capability to select the most appropriate MGCF for routing the call. The SRE 107 forwards the INVITE message to the selected MGCF, which terminates SIP signaling and forwards the call to the PSTN 115 for delivery to the PSTN telephone 116. The SRE 107 is involved only in the signaling path and not in the bearer path. Furthermore, the SRE 107 is involved in the signaling path only during the call establishment phase and not during other phases, such as call termination.

FIG. 1 shows first, second and third integrated routing paths A, B, C that employ various portions of the topology of routing options 106 and one of the media gateways MG1-MG4. The first and second integrated routing paths A, B employ the first media gateway MG1, but employ partially differing pathways that ultimately coincide in the first LATA 115A. Alternatively, the third integrated routing path C employs the fourth media gateway MG4 into the third LATA 115C and then traverses the second and first LATAs 115B, 115A to complete the call.

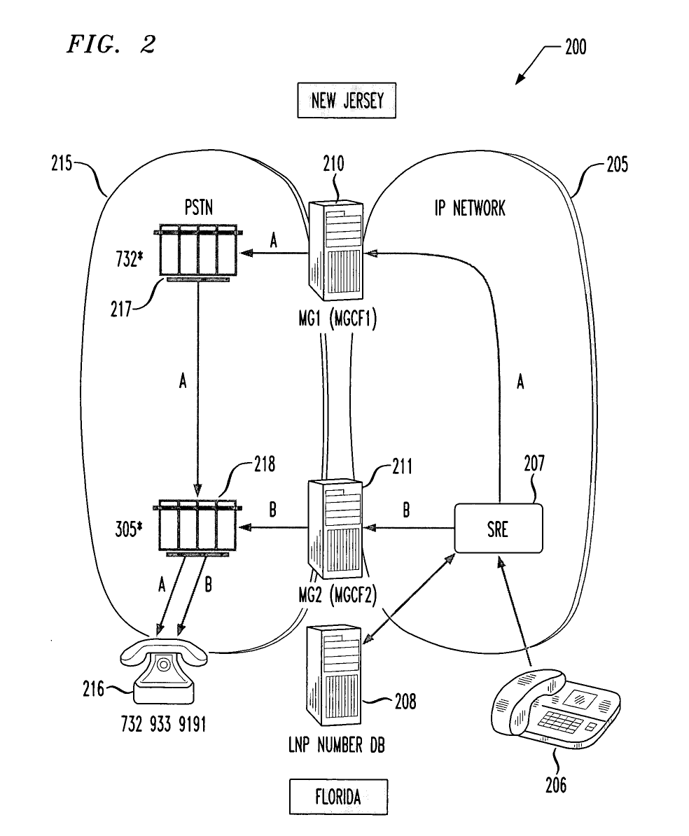

Each of the integrated routing paths may be selected by the SRE 107 based on both call-dependent and call-independent characteristics that exist at the time the call is placed. Call-dependent characteristics may include a load, traffic or distance metric associated with the communications network 100 or a local number portability, for example. Call-independent characteristics may include a network traffic measurement, a media gateway load measurement, a media gateway codec capability or a network policy, for example of course, one skilled in the pertinent art will recognize that other current or future-defined characteristics may be employed as well. In FIGS. 2, 3, 4 and 5, exemplary call routing scenarios are presented wherein a sagacious routing engine is employed to provide an intelligent routing path that resolves a call routing issue.

Turning now to FIG. 2, illustrated is a network diagram of an embodiment of a communications network, generally designated 200, wherein a sagacious routing engine is constructed in accordance with the principles of the present invention and employed to prevent call triangulation. The communications network 200 includes an IP network 205 employing a user agent 206, a PSTN 215 employing a PSTN telephone 216 and first and second telephone switches 217, 218. Although not specifically shown, the communications network 200 also employs a topology of routing options, as was discussed with respect to FIG. 1.

The communications network 200 also includes first and second media gateways 210, 211 (collectively designated the media gateways 210, 211) having corresponding first and second media gateway control functions MGCF1, MGCF2, respectively. The media gateways 210, 211 are coupled to the IP network 205 and the PSTN 215, as shown. The communications network 200 further includes a sagacious routing engine (SRE) 207 that is employed with a SIP call and is coupled to the IP network 205, the PSTN 215, the media gateways 210, 211 and a local number portability (LNP) database 208.

Number portability enables a telephone switch to support numbers outside of its original numbering plan. While typical number portability is restricted to local number portability, which is number portability in a limited geographical region, the trend is toward wide area geographical number portability. For efficient routing, the SRE 207 detects and resolves ported numbers. As shown, PSTN telephone 216 employing telephone number 732-933-9191 is connected to the second telephone switch 218, which is a 305 exchange. Based on the destination number, the call would normally be routed to the first media gateway control function MGCF1 and through the first telephone switch 217 thereby employing a non-optimal routing path A.

However, the SRE 207, functioning as an intelligent network entity, performs a lookup in the LNP database 208 to correctly resolve the destination number. This action routes the call to the second media gateway control function MGCF2 and through the second telephone switch 218 directly thereby providing an integrated routing path B. Of course, this routing scenario may also apply in the case of 8XX toll free number translation. In this case, the SRE 207 performs a lookup in the toll free number database to resolve the toll free number to a routeable PSTN number or Inter-Exchange Carrier (IXC) code.

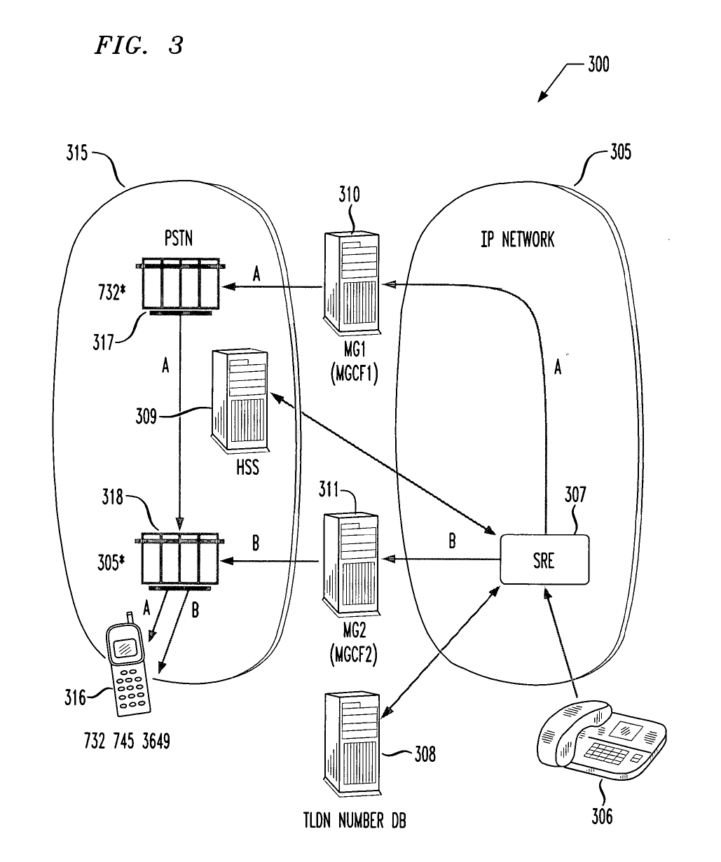

Turning now to FIG. 3, illustrated is a network diagram of an embodiment of a communications network, generally designated 300, wherein a sagacious routing engine, constructed in accordance with the principles of the present invention, is employed to accommodate a roaming mobile phone. The communications network 300 includes an IP network 305 employing a user agent 306, a PSTN 315 employing a PSTN mobile telephone 316 and first and second telephone switches 317, 318. Although not specifically shown, the communications network 300 also employs a topology of routing options.

The communications network 300 also includes first and second media gateways 310, 311 (collectively designated the media gateways 310, 311) having corresponding media gateway control functions MGCF1, MGCF2, respectively. The media gateways 310, 311 are coupled to the IP network 305 and the PSTN 315, as shown. The communications network 300 further includes a sagacious routing engine (SRE) 307 employable with a SIP call and coupled to the IP network 305, the PSTN 315, the media gateways 310, 311, a temporary local directory number (TLDN) database 308 and a home subscriber server (HSS) 309.

The scenario described with respect to FIG. 2 employing number portability and toll free numbers also applies to the wireless case. While roaming, the PSTN mobile telephone 316 may be connected to a switch outside the home network. In such cases, if a call to a roaming mobile phone is sent to its home mobile switching center (MSC) network, it may typically lead to inefficient call routing. For a more optimal routing, the SRE 307 is able to determine the HSS/HLR of the roaming PSTN mobile telephone 316 and to locate its visiting network. The PSTN mobile telephone 316, employing telephone number 732-745-3649, is visiting the second telephone switch 318, which is a 305 exchange. However, based on destination number, the call would be routed to the first telephone switch 317, which is its home network, thereby employing a non-optimal routing path A.

A more optimal routing employs the SRE 107, which performs a wireless number portability (WNP) lookup to determine the appropriate HSS. Next, it queries the HSS 309 to determine the current location of the PSTN mobile telephone 316. Then, the SRE 307 uses the TLDN database 308, returned by the HSS 309, to route the call to the visiting second telephone switch 318 employing an integrated routing path B.

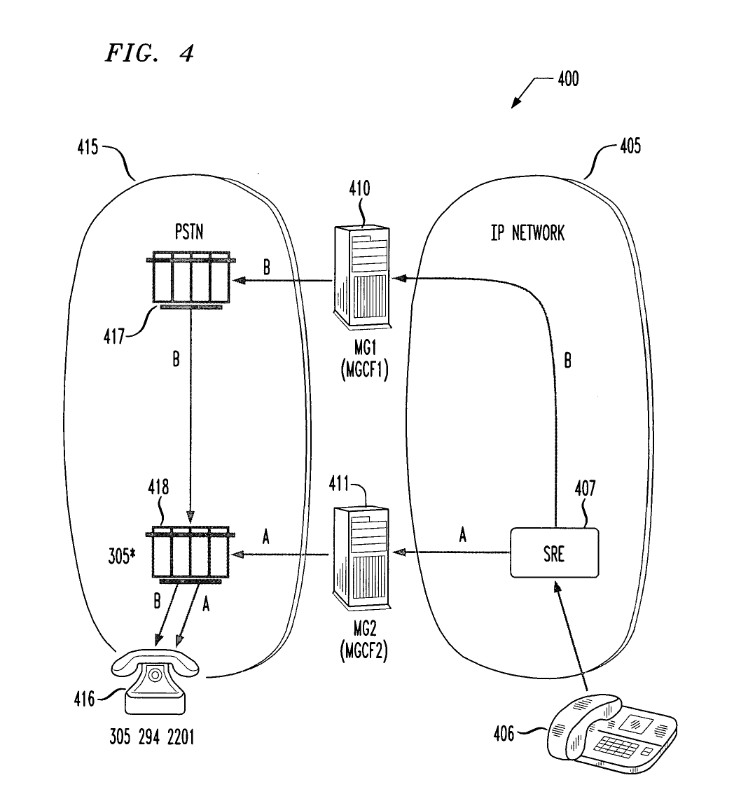

Turning now to FIG. 4, illustrated is a network diagram of an embodiment of a communications network, generally designated 400, wherein a sagacious routing engine is employed to support a feature set employing the principles of the present invention. The communications network 400 includes an IP network 405 employing a user agent 406, a PSTN 415 employing a PSTN telephone 416 and first and second telephone switches 417, 418. Although not specifically shown, a topology of routing options is employed.

The communications network 400 also includes first and second media gateways 410, 411 (collectively designated the media gateways 410, 411) having corresponding media gateway control functions MGCF1, MGCF2, respectively. The media gateways 410, 411 are coupled to the IP network 405 and the PSTN 415, as shown. The communications network 400 further includes a sagacious routing engine (SRE) 407 that is employed with a SIP call and is coupled to the IP network 405, the PSTN 415 and the media gateways 410, 411.

Typically, media gateways and VOIP endpoints (such as the user agent 406) support only a limited set of features. For example, a certain error-resilient audio codec might only be available in certain VOIP endpoints and media gateways. The lack of support for a codec by a media gateway may cause a call to fail, if no matching codecs between the VOIP endpoint and the media gateway can be found. This is the case in FIG. 4 if a non-optimal routing path A were to be used, since the second media gateway 411 does not support the set of features needed to successfully complete the call. Alternatively, in the illustrated embodiment, the first media gateway 410 does provide the needed set of features. Therefore, the call may be successfully completed by an integrated routing path B employing the first media gateway 410, even though the first telephone switch 417 is also employed to route the call.

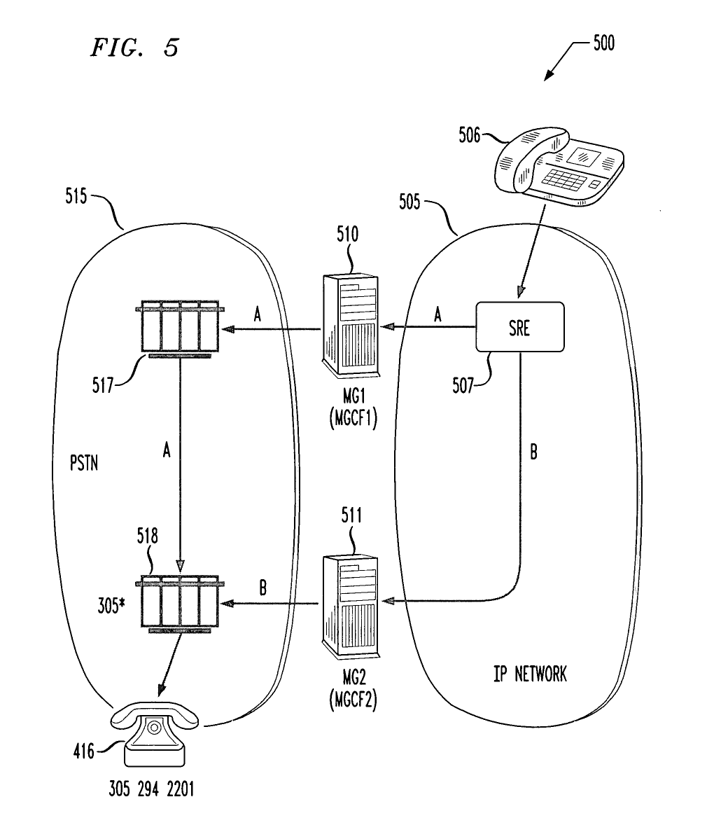

Turning now to FIG. 5, illustrated is a network diagram of an embodiment of a communications network, generally designated 500, wherein a sagacious routing engine is again constructed in accordance with the principles of the present invention and employed to minimize a network distance. The communications network 500 includes an IP network 505 employing a user agent 506, a PSTN 515 employing a PSTN telephone 516 and first and second telephone switches 517, 518. The communications network 500 also employs a topology of routing options.

The communications network 500 also includes first and second media gateways 510, 511 (collectively designated the media gateways 510, 511) having corresponding media gateway control functions MGCF1, MGCF2, respectively. The media gateways 510, 511 are coupled to the IP network 505 and the PSTN 515, as shown. The communications network 500 further includes a sagacious routing engine (SRE) 507 that is employed with a SIP call and is coupled to the IP network 505, the PSTN 515 and the media gateways 510, 511.

IP/PSTN interworking may be better optimized by a suitable selection of a breakout media gateway using policy-based criteria or dynamic load based criteria. For example, a carrier might want to minimize the use of either the IP network 505 or the PSTN 515 depending on a current network status or its current load. Minimizing the network distance in the IP network 505, for example, may mean choosing the media gateway that provides the best audio quality between the media gateway and the caller. This may include selecting the media gateway that minimizes delay, jitter or signal loss. Alternatively, minimizing usage of the PSTN 515 may mean choosing a media gateway that provides either the nearest or the lowest cost termination to the callee.

While the PSTN 515 usually does not show cost variations for short time intervals, the IP network 505 can show considerable variation in the quality of the path from the caller to a media gateway over small time intervals. Therefore, the media gateway selected to minimize the IP path length for a given call may not be suitable for the next call to the same destination. In addition, it may not be as optimal for a call to the same destination made by another endpoint that is connected to a different part of the IP network 505. This may be especially true when the Internet is relied upon for transporting part of a call. As a result, selection of a media gateway that takes the dynamic nature of IP path minimization into account, will typically provide superior network utilization. The SRE 507 may employ either an integrated routing path A or an integrated routing path B depending on a desired minimization of use in either the PSTN 515 or the IP network 505.

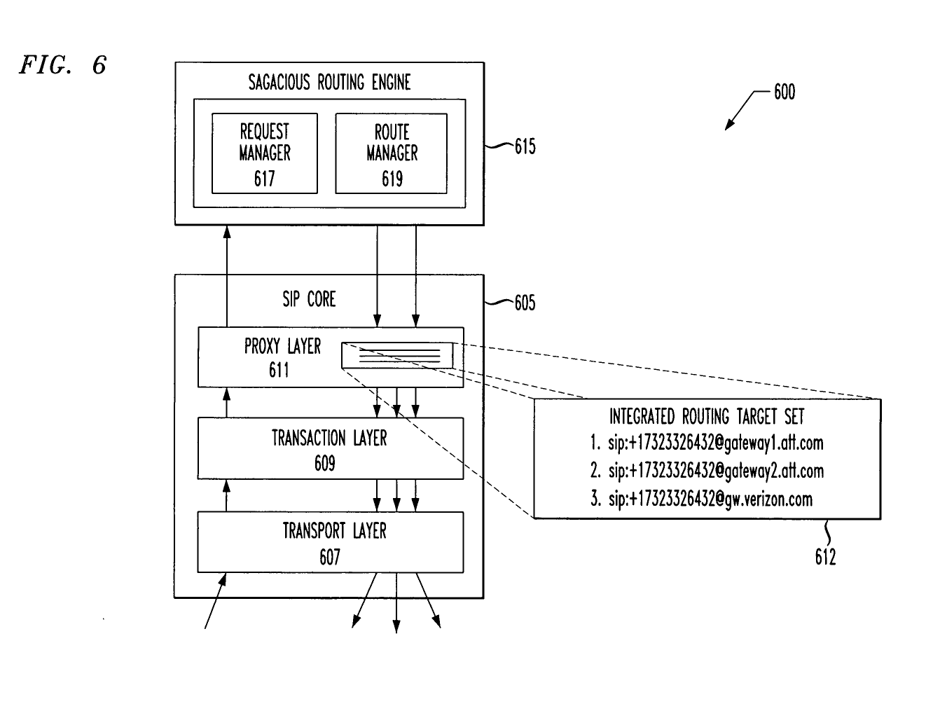

Turning now to FIG. 6, illustrated is a block diagram of an embodiment of an implementation architecture, generally designated 600, employing a sagacious routing engine constructed in accordance with the principles of the present invention. The implementation architecture 600 includes a SIP core 605 and a sagacious routing engine (SRE) 615. The SIP core 605 includes a transport layer 607, a transaction layer 609 and a proxy layer 611. The SRE 615 includes a request manager 617 and a route manager 619. In the illustrated embodiment, the SRE 615 forms an application layer for the SIP core 605.

The transport layer 607 forms the bottom layer of the SIP core 605, employs transport protocols and is responsible for receiving SIP messages from external SIP entities. These SIP messages are passed to the transaction layer 609, which maintains the necessary SIP transaction state for the current SIP transaction. The Proxy layer 611 forms the next layer and is responsible for forwarding a SIP message to an integrated routing target set 612 employing serial/parallel forking.

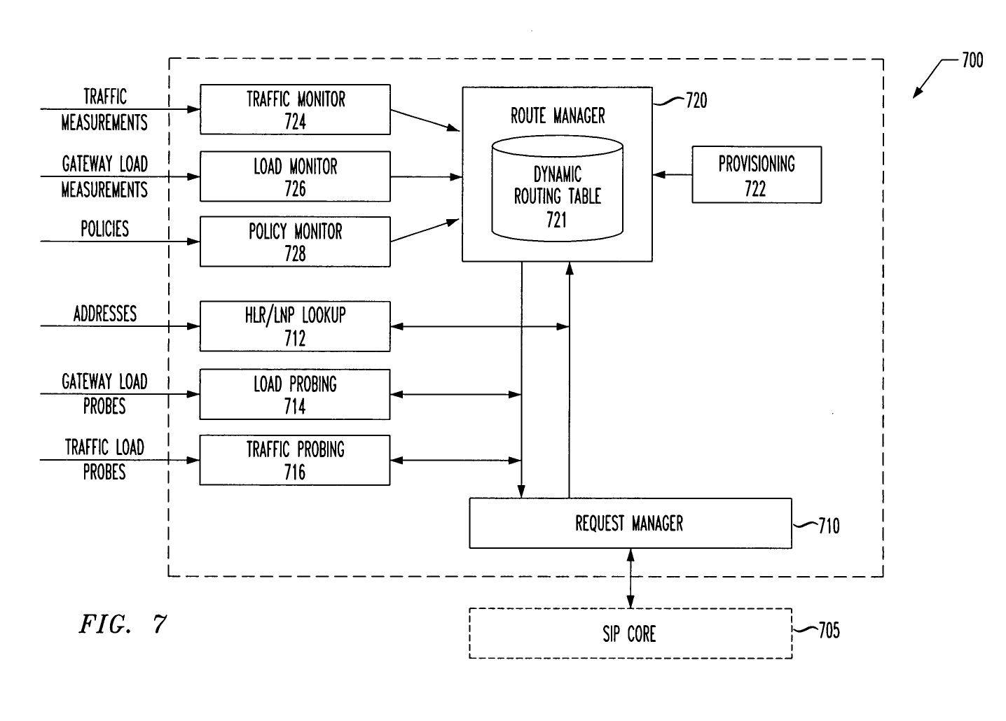

The integrated routing target set 612, which is the ordered set of alternate SIP destinations (as noted earlier) is generated by the SRE 615. The SRE 615 employs a method of routing the SIP call by receiving a routing request for the integrated routing target set 612 and additionally employs a dynamic routing table for the routing request to provide the integrated routing target set 612. The method employs at least one call-independent characteristic in a determination of the integrated routing target set 612 for routing the SIP call within a network. Additionally, the method may employ at least one call-dependent characteristic that enhances the integrated routing target set 612. A more detailed discussion of SRE operation is presented in FIG. 7, below.

Turning now to FIG. 7, illustrated is a system diagram of an embodiment of a sagacious routing engine, generally designated 700, constructed in accordance with the principles of the present invention. The sagacious routing engine (SRE) 700 is associated with a SIP core 705 and includes a request manager 710 and a route manager 720 having a dynamic routing table 721. In the illustrated embodiment, the request manager 710 is associated with a home location register/local number portability (HLR/LNP) lookup module 712, a load probing module 714 and a traffic probing module 716. As shown, the route manager 720 is associated with a provisioning module 722, a traffic monitor module 724, a load monitor module 726 and a policy monitor module 728. Of course, the illustrated configurations of the request manager 710 and the route manager 720 are exemplary, and alternative embodiments may employ other modules or module configurations as appropriate to a particular application.

The SRE 700 is employed with a SIP call, and the request manager 710 is configured to receive a routing request for an integrated routing target set associated with the SIP call within a network, such as the communications network 100 as discussed with respect to FIG. 1. The route manager 720 is coupled to the request manager 710 and is configured to employ the dynamic routing table 721 for the routing request and to provide the integrated routing target set to the request manager 710 for routing the SIP call within the network.

The architecture of the SRE 700 provides a framework for an implementation of advanced gateway selection algorithms that may be employed in the scenarios described above. This architecture is based on a functional approach to gateway selection. In the illustrated embodiment, implementation of the SRE 700 is located in an applications level of the SIP core 705 and provides selection of a media gateway. The SIP core 705 provides the functionalities needed by a transaction-stateful SIP proxy and passes SIP requests to the SRE 700 when a routing decision needs to be made.

The request manager 710 implements the interface to the SIP core 705 wherein it marshals incoming requests and dispatches them to the Route Manager 720. The Route Manager 720 employs a database containing the dynamic routing table 721. It should be noted that routing refers to media gateway selection and not hop-by-hop path selection. Based on the implementation of the Route Manager 720, the dynamic routing table 721 can either be local or remote. Having the dynamic routing table 721 allows the SRE 700 to be added to an existing VOIP network with minimal disruption by utilizing an existing gateway selection process. In such a network, the SRE 700 provides added value by implementing the modules such as the HLR/LNP lookup module 716 or the traffic probing module 716 locally. Remote access to the route manager 720 is also useful in building a network with multiple SREs in which a global database is partitioned into a set of disjoint databases, where each SRE in the network manages a subset of a global routing table.

Besides maintaining the dynamic routing table 721, the route manager 720 employs the provisioning module 722 to enable network providers to manage dynamic routing table entries. The dynamic routing table 721 provides a mapping from an incoming request to an ordered list of media gateways that may be employed by the request. The media gateways are identified using a SIP uniform resource identifier (URI) (i.e., the SIP address) of their controlling entities, which are the MGCFs in an IMS network. The route manager 720 resolves a call request into an ordered list of SIP URIs of media gateways, which is called the integrated routing target set for that request. This integrated routing target set is returned to the request manager 710, which passes it to the SIP core 705. The SIP core 705 performs serial forking on this integrated routing target set thereby causing the SIP core 705 to first route the request to the media gateway at the head of the integrated routing target set. If this gateway is not able to complete the call, the SIP core 705 routes the request to the next SIP URI in the integrated routing target set and so on. In the case where the integrated routing target set is exhausted, the request has failed and an error is returned to the sender.

The modules associated with the request manager 710 are call-dependent modules, which are called during the processing of an individual request. Therefore, the request manager 710 invokes the call-dependent modules each time a request is processed. These modules may be divided into two types. Those that need to be called before a request is handed to the route manager 720, and those that operate on the integrated routing target set returned by the route manager 720. For example, the HLR/LNP module 712 is employed before the request is handed off, and the load and traffic probing modules 714, 716 operate on the returned integrated routing target set. The HLR/LNP module 712, for example, takes an incoming request and remaps it into a new request based on the HLR/LNP module 712 response thereby obtaining the route to the correct, fully resolved number.

The load probing and traffic probing modules 714, 716, on the other hand, reorder the integrated routing target set returned by the route manager 720 to reflect the latest network topology and congestion information. This action thereby enhances the integrated routing target set provided by the dynamic routing table 721.

The modules associated with the route manager 720 are call-independent modules and are independent of the processing of individual requests. The call-independent modules manipulate the dynamic routing table 721 so that subsequent requests benefit from their results. For example, the load monitor 726 monitors the load on individual media gateways and deletes dynamic routing table entries of a particular media gateway, if that media gateway is overloaded or unavailable. Similarly, the traffic monitor 724 weights each media gateway with a metric dependent on the network congestion towards that media gateway from each network entry point. The policy monitor 728 provides the routing and network policies that are generally applicable to all requests.

The SRE 700 may serve as a framework for adding or deleting modules thereby allowing considerable flexibility in customizing it to the individual characteristics associated with a particular network or environment. For example, a small VOIP network that employs only a few media gateways may not require all the modules associated with the illustrated embodiment of FIG. 7. Additionally, an alternative embodiment of an SRE may require additional or differing modules for added functionality or quality of service performance to appropriately support call routing in an alternative network environment.

In summary, embodiments of the present invention employing a sagacious routing engine, a method of routing a SIP call and a communications network that employs the engine or the method have been presented. Specific examples presented include reducing call triangulation, accommodating local number portability and roaming cell phones, assessing media gateway loading and selecting a media gateway based on its feature set (codec, etc.) capability. Of course, other routing improvements may be employed by one skilled in the pertinent art that are well within the broad scope of the present invention.

General advantages of dynamic call routing include better utilization of network infrastructure and current operating condition while maintaining or improving a quality of service for the call. A static-based approach typically deals with delay variations and connecting endpoints through different links only by over-provisioning the network bandwidth. The measurement-based dynamic approach to IP path minimization presented may use an existing network bandwidth more efficiently by routing calls to those media gateways that provide the best quality for a particular call.

Using this approach, a number of calls may be maximized by accepting all calls up to a given delay threshold, thereby leading to a lower call rejection ratio. Alternately, for a given number of calls in a communications network, the media gateways may be select to minimize a delay, jitter or loss-rate, thereby providing consistently better voice quality as compared to a static routing table approach. Selection of media gateways that take network characteristics into account require feedback about the current status of the network. This network monitoring can be done by actively probing the relevant characteristics.

However, it may be unrealistic to send probes from every media gateway to an endpoint to determine the best path for a certain call. This would increase the call setup time, since routing decisions can only be made after collecting all responses. The probes would also significantly increase the load in the network and thereby reduce the number of actual calls the network could handle. However, active probing is powerful and can be used to discover specific characteristics between two given points such as the number of hops required between the two points.

Another approach is to passively monitor the quality of current calls and use this information to determine the current status of the network. This may lead to results that are not as accurate as active probing, since passive measurements are usually not available for a given endpoint-gateway pair. However, it enables the computation of a link load estimate, especially if the network topology is known, without introducing additional load on the network. An approach that combines both types of measurements and uses active probing to determine characteristics that are not available through passive monitoring allows an adaptive level of routing path integration to be accommodated.

Although the present invention has been described in detail, those skilled in the art should understand that they can make various changes, substitutions and alterations herein without departing from the spirit and scope of the invention in its broadest form.

What is claimed is:

1. A sagacious routing engine for use with a session initiation protocol (SIP) call, comprising:
a request manager configured to receive a routing request for an integrated routing target set for said SIP call within a network; and
a route manager, coupled to said request manager, configured to employ a dynamic routing table for said routing request and to provide said integrated routing target set to said request manager for routing said SIP call within said network.

2. The engine as recited in claim 1 wherein said route manager employs said dynamic routing table to provide said integrated routing target set based on a call-independent characteristic selected from the group consisting of:
a network traffic measurement;
a media gateway load measurement;
a media gateway codec capability; and
a network policy.

3. The engine as recited in claim 1 wherein said request manager is further configured to enhance said integrated routing target set based on a call-dependent characteristic selected from the group consisting of:
a local number portability; and
a probe associated with said network.

4. The engine as recited in claim 1 wherein said route manager is located remotely from said request manager.

5. The engine as recited in claim 1 wherein said network includes an Internet protocol (IP) domain and a public switched telephone network (PSTN) domain.

6. The engine as recited in claim 1 wherein said network is selected from the group consisting of:
a wireless network;
a wireline network; and
a hybrid network.

7. The engine as recited in claim 1 wherein said integrated routing target set is associated with an agent selected from the group consisting of:
a stationary user agent; and
a mobile user agent.

8. A method of routing a session initiation protocol (SIP) call, comprising:
receiving a routing request for an integrated routing target set for said SIP call within a network; and
employing a dynamic routing table for said routing request to provide said integrated routing target set for routing said SIP call within said network.

9. The method as recited in claim 8 wherein said employing said dynamic routing table to provide said integrated routing target set is based on a call-independent characteristic selected from the group consisting of:
a network traffic measurement;
a media gateway load measurement;
a media gateway codec capability; and
a network policy.

10. The method as recited in claim 8 wherein said integrated routing target set is enhanced based on a call-dependent characteristic selected from the group consisting of:
a local number portability; and
a probe associated with said network.

11. The method as recited in claim 8 wherein said receiving said routing request and said employing said dynamic routing table are remotely located.

12. The method as recited in claim 8 wherein said network includes an Internet protocol (IP) domain and a public switched telephone network (PSTN) domain.

13. The method as recited in claim 8 wherein said network is selected from the group consisting of:
a wireless network;
a wireline network; and
a hybrid network.

14. The method as recited in claim 8 wherein said integrated routing target set is associated with an agent selected from the group consisting of:
a stationary user agent; and
a mobile user agent.

15. A communications network, comprising:
an Internet protocol (IP) domain;
a public switched telephone network (PSTN) domain;
a sagacious routing engine, coupled to said IP domain and said PSTN domain, for use with a session initiation protocol (SIP) call, including:
a request manager that receives a routing request for an integrated routing target set for said SIP call; and
a route manager, coupled to said request manager, that employs a dynamic routing table for said routing request to provide said integrated routing target set to said request manager for routing said SIP call; and
a media gateway, coupled to said IP domain and said PSTN domain, that constitutes at least a portion of said integrated routing target set for routing said SIP call.

16. The network as recited in claim 15 wherein said route manager employs said dynamic routing table to provide said integrated routing target set based on a call-independent characteristic selected from the group consisting of:
a network traffic measurement;
a media gateway load measurement;
a media gateway codec capability; and
a network policy.

17. The network as recited in claim 15 wherein said request manager enhances said integrated routing target set based on a call-dependent characteristic selected from the group consisting of:
a local number portability; and
a probe associated with said network.

18. The network as recited in claim 15 wherein said route manager is located remotely from said request manager.

19. The network as recited in claim 15 wherein said network is selected from the group consisting of:
a wireless network;
a wireline network; and
a hybrid network.

20. The network as recited in claim 15 wherein said integrated routing target set is associated with an agent selected from the group consisting of:
a stationary user agent; and
a mobile user agent.
